(19) United States
(12) Patent Application Publication
(10) Pub. No.: US 2026/0245026 A1
(43) Pub. Date: Aug. 20, 2026

(54) SYSTEM AND METHOD FOR PROVIDING LOADING INFORMATION

(71) Applicant: NEC Corporation, Tokyo (JP)

(72) Inventor: Hiroka NAGASE, Tokyo (JP)

(73) Assignee: NEC Corporation, Tokyo (JP)

(21) Appl. No.: 19/529,516

(22) Filed: Feb. 4, 2026

(30) Foreign Application Priority Data
Feb. 18, 2025 (JP) 2025-024185

(51) Int. Cl. G06Q 10/083; G06Q 10/04

(52) U.S. Cl. CPC G06Q 10/083; G06Q 10/04

(57) ABSTRACT

Provided is a method for providing loading information, in which a computer acquires cargo information regarding a cargo including a product to be loaded and frequency information indicating a replenishment frequency or an order frequency at a delivery destination, and in a case where the cargo information and the frequency information are input, outputs loading information by using the loading information generation model that generates the loading position information indicating the position of the cargo to be loaded on the loading platform of the vehicle that transports the cargo and/or the loading order information indicating the loading order of the cargo. The loading position information indicates an arrangement position where, in the loading, a cargo including a product having a high replenishment frequency or order frequency is located on the lower side or the back side of a cargo including a product having a low replenishment frequency or order frequency.

### INCORPORATION BY REFERENCE

This application is based upon and claims the benefit of priority from Japanese patent application No. 2025-24185, filed on February 18, 2025, the disclosure of which is incorporated herein in its entirety by reference.

### TECHNICAL FIELD

The present disclosure relates to a system, an information processing device, a method, and a non-transitory recording medium for providing loading information regarding loading of cargos.

### BACKGROUND ART

Conventionally, there has been proposed a technique for providing information regarding loading of cargos. As an example of such a technology, JP 2024-42345 A discloses a loading position planning device that generates loading position plan information indicating a loading position of an object in a container by allocating item information relevant to an object to be loaded to a predetermined position in container information relevant to a container to be loaded using a predetermined parameter.

### SUMMARY

However, the loading position planning device disclosed in JP 2024-42345 A has a problem that it is not possible to provide the loading information that makes the replenishment work of products efficient.

An example object of the present disclosure is to provide a system, a method, and a non-transitory recording medium capable of providing loadinginformation that makes replenishment work of products efficient.

A computer implemented method for providing loading information according to a first example aspect of the present disclosure including

acquiring cargo information regarding a cargo including a product to be loaded and frequency information indicating a replenishment frequency or an order frequency at a delivery destination of the product, and

outputting the loading information by using a loading information generation model that generates, in a case where the cargo information and the frequency information are input, loading information including at least one of loading position information indicating a position of the cargo to be loaded on a loading platform of a vehicle that transports the cargo and loading order information indicating a loading order of the cargo, in which

the loading position information indicates an arrangement position where, in the loading of the cargo, a cargo including a product having a high replenishment frequency or order frequency is on a lower side or a back side of a cargo including a product having a low replenishment frequency or order frequency, and

the loading order information indicates an order in which, in the loading, a cargo including a product having a high replenishment frequency or order frequency is arranged on a lower side or a back side of the loading platform, and then a cargo including a product having a low replenishment frequency or order frequency is arranged on an upper side or a front side of a cargo including a product having a high replenishment frequency or order frequency.

A computer implemented method for providing loading information according to a second example aspect of the present disclosure including

acquiring cargo information regarding a cargo including a product to be loaded and stock-out tendency information indicating a stock-out tendency at a delivery destination of the product, and

outputting the loading information by using a loading information generation model that generates, in a case where the cargo information and the stock-out tendency information are input, loading information including at least one of loading position information indicating a position of the cargo to be loaded

on a loading platform of a vehicle that transports the cargo and loading order information indicating a loading order of the cargo, in which

the loading position information indicates an arrangement position where, in the loading of the cargo, a cargo including a product having a high stock-out tendency is on a lower side or a back side of a cargo including a product having a low stock-out tendency, and

the loading order information indicates an order in which, in the loading, a cargo including a product having a high stock-out tendency is arranged on a lower side or a back side of the loading platform, and then a cargo including a product having a low stock-out tendency is arranged on an upper side or a front side of the loading platform of a cargo including a product having a high stock-out tendency.

A system for providing loading information according to a third example aspect of the present disclosure including

at least one memory configured to store instructions, and

at least one processor configured to execute the instructions to

acquire cargo information regarding a cargo including a product to be loaded and frequency information indicating a replenishment frequency or an order frequency at a delivery destination of the product, and

output the loading information by using a loading information generation model that generates, in a case where the cargo information and the frequency information are input, loading information including at least one of loading position information indicating a position of the cargo to be loaded on a loading platform of a vehicle that transports the cargo and loading order information indicating a loading order of the cargo, in which

the loading position information indicates an arrangement position where, in the loading of the cargo, a cargo including a product having a high replenishment frequency or order frequency is on a lower side or a back side of a cargo including a product having a low replenishment frequency or order frequency, and

the loading order information indicates an order in which, in the loading, a cargo including a product having a high replenishment frequency or order frequency is arranged on a lower side or a back side of the loading platform, and then a cargo including a product having a low replenishment frequency or order

frequency is arranged on an upper side or a front side of a cargo including a product having a high replenishment frequency or order frequency.

According to the present disclosure, it is possible to provide a system, an information processing device, a method, and a non-transitory recording medium capable of providing loading information for making replenishment work of products efficient.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a schematic diagram illustrating an example of a loading information providing system according to the present disclosure;

FIG. 2 is a diagram illustrating an exemplary hardware configuration of the information processing device according to the present disclosure;

FIG. 3 is a diagram illustrating an exemplary hardware configuration of a user terminal device according to the present disclosure;

FIG. 4 is a diagram illustrating an example of a functional configuration of an information processing device according to the present disclosure;

FIG. 5 is a diagram illustrating an example of a functional configuration of another information processing device according to the present disclosure;

FIG. 6 is a diagram illustrating an example of input information and output information of a loading information generation model according to the present disclosure;

FIG. 7 is a diagram illustrating an example of an image on which loading information is displayed;

FIG. 8 is a diagram illustrating an example of a functional configuration of a user terminal device according to the present disclosure;

FIG. 9 is a sequence diagram illustrating an example of processing executed by the information processing device according to the present disclosure;

FIG. 10 is a diagram illustrating main components included in the information processing device according to the present disclosure; and

FIG. 11 is a diagram illustrating an example of information indicating an arrangement position of a cargo including a delivery target product at a delivery destination.

### EXAMPLE EMBODIMENTS

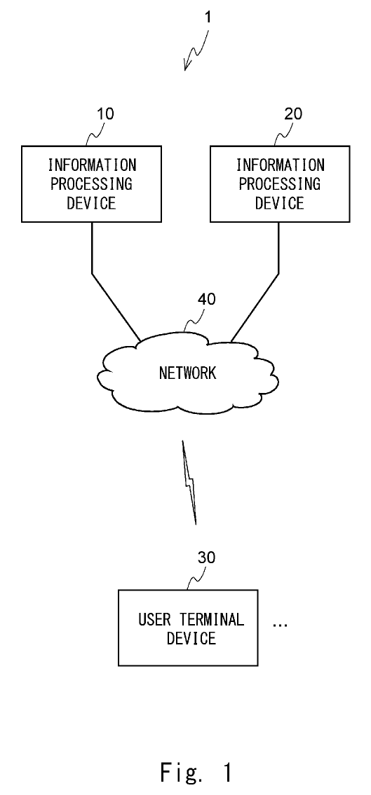

Hereinafter, an example embodiment will be described with reference to the drawings. FIG. 1 is a schematic diagram illustrating an example of a loading information providing system 1 according to the present disclosure. The loading information providing system 1 includes an information processing device 10, an information processing device 20, and a user terminal device 30. The loading information providing system 1 may include a plurality of user terminal devices 30.

The information processing device 10 communicates data with the information processing device 20 and the user terminal device 30 via a network 40. The network 40 may include a wide area network such as the Internet and a narrow area network such as a local area network (LAN) or the like.

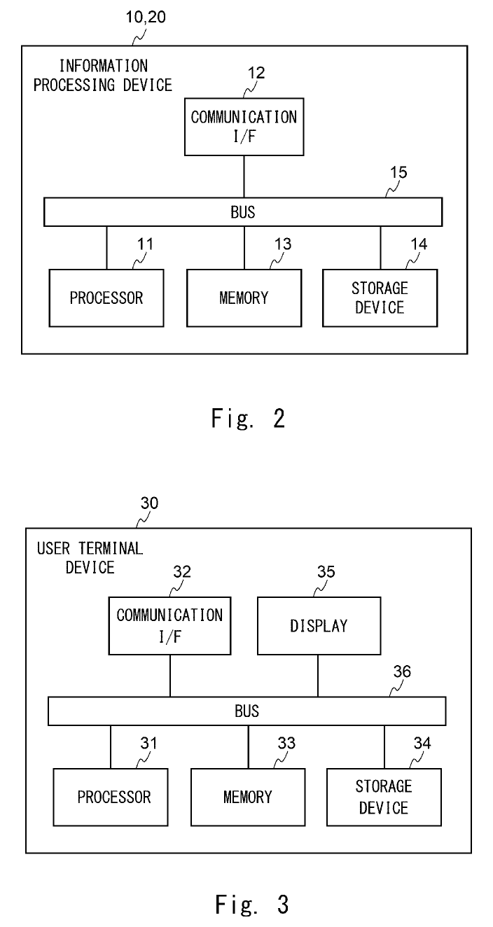

FIG. 2 is a schematic diagram illustrating an exemplary hardware configuration of the information processing devices 10 and 20. Specific examples of the information processing devices 10 and 20 include a server and the like. The information processing devices 10 and 20 include a processor 11, a communication interface (I/F) 12, a memory 13, and a storage device 14. These devices exchange data via a bus 15.

The processor 11 is a device that performs overall control of the information processing devices 10 and 20. Specific examples of the processor 11 are a processor, such as a central processing unit (CPU), a graphics processing unit (GPU), and a micro processing unit (MPU). The processor 11 loads the program stored in the storage device 14 into the memory 13 and executes the program, thereby executing the method defined by the program. In another

example embodiment, the function executed by the processor 11 may also be executed by an integrated circuit such as a field-programmable gate array (FPGA) or an application specific integrated circuit (ASIC). These devices are equivalent to a computer.

The communication interface 12 is an interface that performs data communication between the information processing devices 10 and 20 and another device. The storage device 14 stores various data such as a program executed by the processor 11 and data processed by the processor 11.

FIG. 3 is a diagram illustrating an exemplary hardware configuration of the user terminal device 30. Specific examples of the user terminal device 30 include a smartphone and a tablet terminal device. The user terminal device 30 includes a processor 31, a communication interface (I/F) 32, a memory 33, a storage device 34, and a display 35. These devices exchange data via a bus 36.

The processor 31 is a device that performs overall control of the user terminal device 30. Specific examples of the processor 31 include various processors such as a CPU, a GPU, and an MPU. The processor 31 loads the program stored in the storage device 34 into the memory 33 and executes the program, thereby executing the method defined by the program. In another example embodiment, the function executed by the processor 31 may also be executed by an integrated circuit such as FPGA or ASIC. These devices are equivalent to a computer.

The communication interface 32 is an interface that performs data communication between the user terminal device 30 and another device. The storage device 34 stores various data such as a program executed by the processor 31 and data processed by the processor 31.

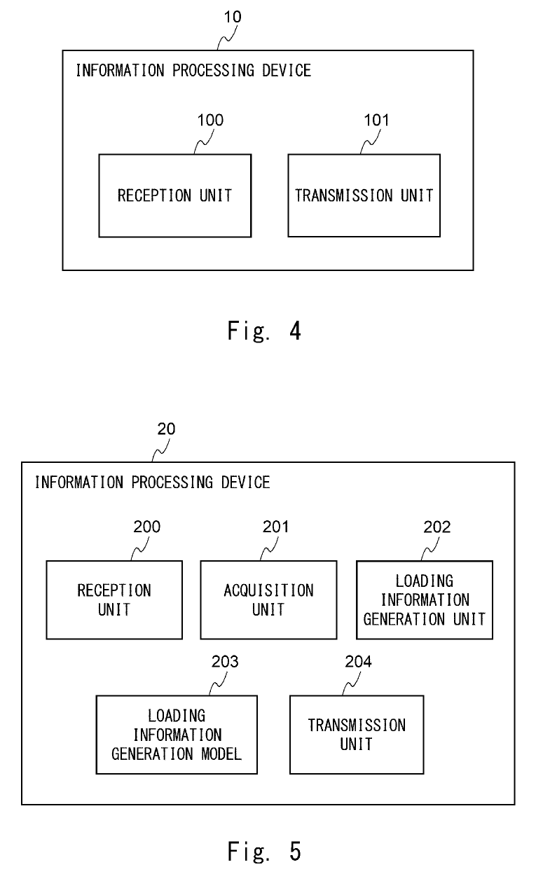

FIG. 4 is a diagram illustrating an example of a functional configuration of the information processing device 10. The information processing device 10 includes a reception unit 100 and a transmission unit 101. These functional means can be implemented by a program.

The reception unit 100 acquires various types of information from other devices. The information received by the reception unit 100 includes cargo information regarding a cargo including the product to be loaded, frequency information indicating a replenishment frequency or an order frequency at a delivery destination of the products to be loaded, and transport order information indicating a transport order of the cargo including the product to be loaded to the delivery destination.

The transmission unit 101 transmits various types of information to other devices. Specifically, the transmission unit 101 transmits the cargo information, the frequency information, and the transport order information received by the reception unit 100 to the information processing device 20.

FIG. 5 is a diagram illustrating an example of a functional configuration of the information processing device 20. The information processing device 10 includes a reception unit 200, an acquisition unit 201, a loading information generation unit 202, a loading information generation model 203, and a transmission unit 204. These functional means can be implemented by a program.

The reception unit 200 receives various types of information transmitted by the information processing device 10. The information received by the reception unit 200 includes the cargo information, the frequency information, and the transport order information transmitted by the information processing device 10.

The acquisition unit 201 acquires the cargo information, the frequency information, and the transport order information received by the reception unit 200.

The loading information generation unit 202 inputs the cargo information, the frequency information, and the transport order information acquired by the acquisition unit 201 to the loading information generation model 203 to output the loading information.

The loading information generation model 203 is a program that generates loading information including at least one of loading position information indicating a position of a cargo to be loaded on a loading platform of a vehicle that transports the cargo including a product to be loaded and loading order information indicating a loading order of the cargo. A specific example of the loading information generation model 203 is a large language model (LLM) or the like. The loading information generation model 203 is optimized by machine learning such as deep learning. The loading information generation model 203 receives various instruction information (prompts).

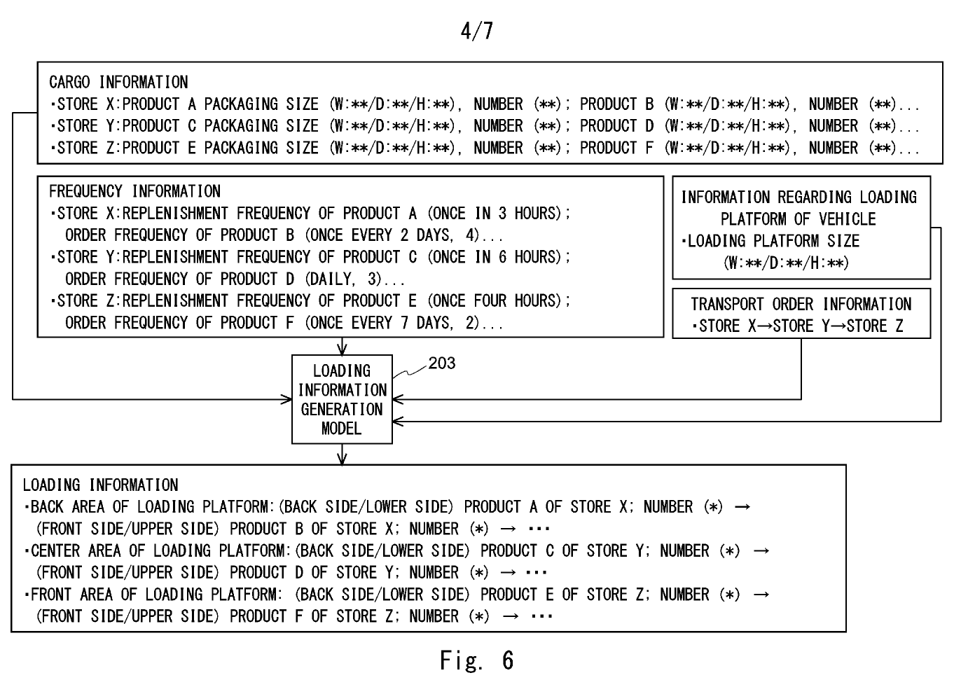

The loading information generation model 203 uses the cargo information, the frequency information, and the transport order information acquired by the acquisition unit 201 as input information. FIG. 6 is a diagram illustrating an example of input information and output information of the loading information generation model 203. The cargo information includes identification information (such as a product name) of a product, a size (packing size) of a cargo including the product, and the number of pieces of cargo. These pieces of information are associated with identification information (store name or the like) of the store. The frequency information includes information indicating an order frequency of the product for each store and/or information indicating a replenishment frequency of the product.

In a case where the cargo information and the frequency information are input, the loading information generation model 203 is optimized by machine learning so as to output, in the loading, the loading position information indicating the arrangement position where the cargo including the product with a high replenishment frequency or order frequency is on the lower side or the back side of the cargo including the product with a low replenishment frequency or order frequency. The loading position information is equivalent to the loading information. The loading information generation model 203 can be learned so as to output the number of cargos to be loaded for each store and each product.

In a case where the cargo information and the frequency information are input, the loading information generation model 203 is optimized by machine learning so as to output, in the loading, the loading order information indicating the order of arranging the cargo including the product with a low replenishment frequency or order frequency on the upper side or the front side of the cargo including the product with a high replenishment frequency or order frequency after arranging the cargo including the product with a high replenishment frequency or order frequency on the lower side or the back side of the loading platform. The loading order information is equivalent to the loading information. The loading information generation model 203 can be learned so as to output the number of cargos to be loaded for each store and each product.

Furthermore, in a case where the cargo information and the transport order information are input, the loading information generation model 203 is optimized by machine learning so as to output, in the loading, the loading position information indicating the arrangement position where the cargo including the product of the later transport order is on the back side of the loading platform and the cargo including the product of the earlier transport order is on the front side of the product of the later transport order.

Furthermore, in a case where the cargo information and the transport order information are input, the loading information generation model 203 is optimized by machine learning so as to output, in the loading, the loading order information indicating the order in which the cargo including the product of the earlier transport order is arranged on the front side of the cargo including the product of the later transport order after the cargo including the product of the later transport order is arranged on the back side of the loading platform.

Alternatively, in a case where the position information indicating the loading position of the cargo and the position information of the transport destination of the cargo are input, the loading information generation model 203 may be optimized by machine learning so as to output, in the loading, the loading position information indicating the arrangement position where the cargo including the product of the predetermined later transport order based on the position information indicating the loading position and the position information of the transport destination is on the back side of the loading platform, and the cargo including the product of the earlier transport order is on the front side of the product of the later transport order. The predetermined transport order may be an order with good transport efficiency.

In a case where the position information indicating the loading position of the cargo and the position information of the transport destination of the cargo are input, the loading information generation model 203 may be optimized by machine learning so as to output, in the loading, the loading order information indicating the order of arranging the cargo including the product of the earlier transport order on the front side of the cargo including the product of the later transport order after arranging the cargo including the product of the predetermined later transport order on the back side of the loading platform based on the position information indicating the loading position and the position information of the transport destination.

As illustrated in FIG. 6, the loading information includes the loading position information, the identification information of the product for each delivery destination store, the number of cargos including the product, and the loading order information. In the example of FIG. 6, the “back area of the loading platform”, the “center area of the loading platform”, the “front area of the loading platform”, the “back side”, the “lower side”, the “front side”, and the “upper side” are relevant to the loading position information. An arrow in the loading information illustrated in FIG. 6 is relevant to the loading order information.

The loading information illustrated in FIG. 6 indicates that the cargo including the product A of the store X is loaded on the back side or the lower side in the back area of the loading platform, and then the cargo including the product B of the store X is loaded on the front side or the upper side. The loading information indicates that the cargo including the product C of the store Y is loaded on the back side or the lower side in the center area of the loading platform, and then the cargo including the product D of the store Y is loaded on the front side or the upper side. Further, the loading information indicates that the cargo including the product E of the store Z is loaded on the back side or the lower side in the front area of the loading platform, and then the cargo including the product F of the store Z is loaded on the front side or the upper side.

Furthermore, the loading information generation model 203 may be optimized by machine learning so as to output the loading position information and the loading order information of the cargo that minimizes the empty space of the loading platform in a case where the size of the loading platform, which is information regarding the loading platform of the vehicle, is input.

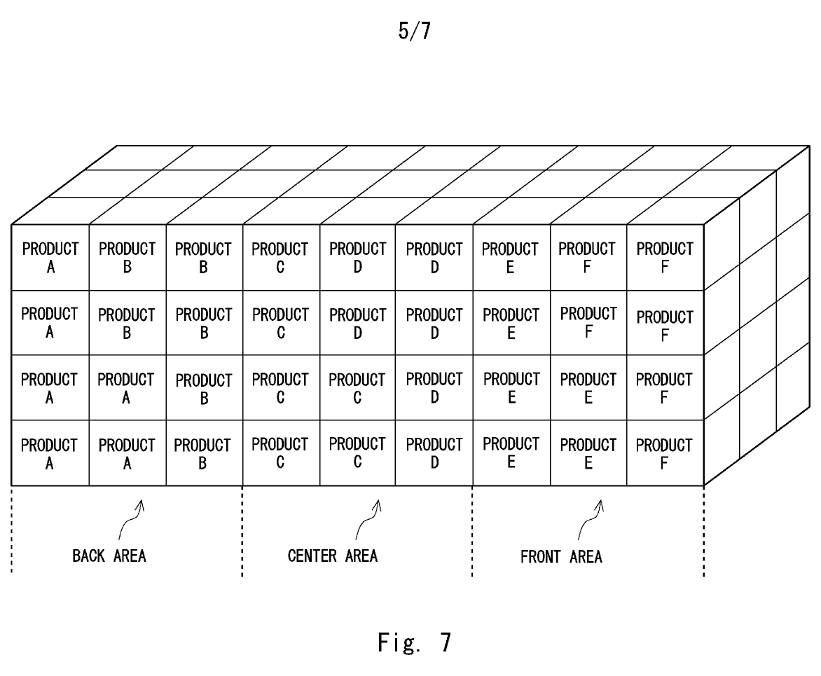

Furthermore, as illustrated in FIG. 7, the loading information generation model 203 may be optimized by machine learning so as to generate and output an image three-dimensionally displaying the loading information. In the example of FIG. 7, the cargo loaded on the loading platform of the vehicle is displayed in the form of a perspective view.

Further, the loading information generation model 203 may be optimized by machine learning so as to output information indicating a reason and a basis of the loading information together with the loading information. The reason and basis of the loading information include information indicating the merit of the loading information, for example, information indicating that the time required for searching for, unpacking, and carrying the replenishment target product at the delivery destination is reduced.

Further, the loading information generation model 203 may be optimized by machine learning so as to output a plurality of different pieces of loading information. In this case, the loading information generation model 203 may be optimized by machine learning so as to output information indicating merits and demerits of each loading information.

Further, the loading information generation model 203 may learn the cargo information including the weight of the cargo as the input information.

The transmission unit 204 transmits the loading information output from the loading information generation model 203 to the information processing device 10. The transmission unit 204 is equivalent to an output unit.

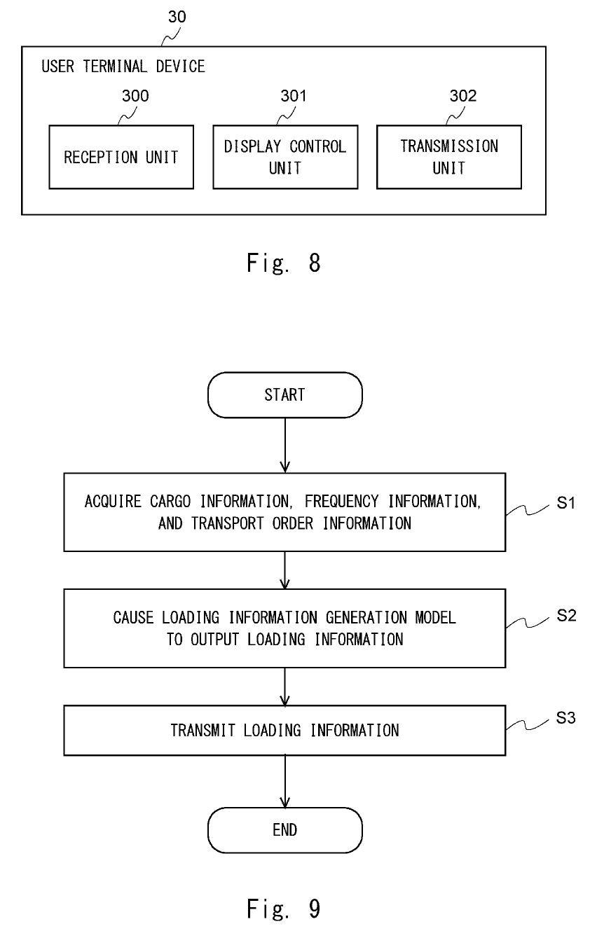

FIG. 8 is a diagram illustrating an example of a functional configuration of the user terminal device 30. The user terminal device 30 includes a reception unit 300, a display control unit 301, and a transmission unit 302. These functional means can be implemented by a program.

The reception unit 300 receives various types of information from other devices. The information received by the reception unit 300 includes the loading information transmitted by the information processing device 10.

The display control unit 301 displays various types of information on the display 35 of the user terminal device 30. Specifically, the display control unit 301 displays the loading information received by the reception unit 300 on the display 35.

The transmission unit 302 transmits various types of information to other devices. Specifically, the transmission unit 302 can transmit, to the information processing device 10, information to be used for generation of the loading information by the loading information generation model 203.

FIG. 9 is a sequence diagram illustrating an example of the processing executed by the information processing device 20. In step S1, the acquisition unit 201 acquires the cargo information, the frequency information, and the transport order information. In step S2, the loading information generation unit 202 inputs the cargo information, the frequency information, and the transport order information to the loading information generation model 203, and causes the loading information to be output. In step S3, the transmission unit 204 transmits the loading information to the information processing device 10, and the process illustrated in FIG. 9 ends.

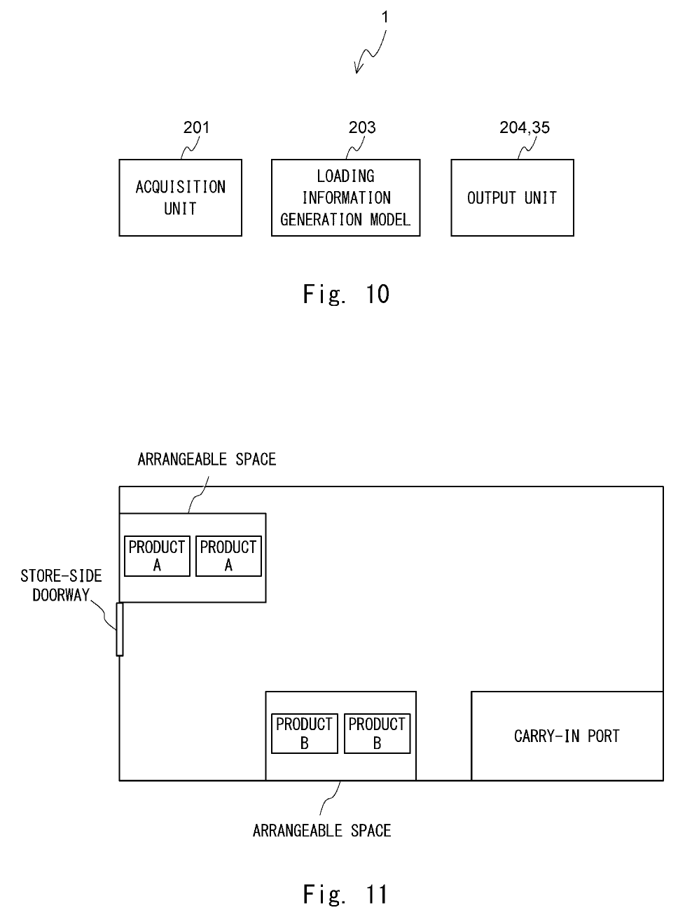

FIG. 10 is a diagram illustrating main components included in the The loading position information indicates an arrangement position where, in the loading, a cargo including a product having a high replenishment frequency or order frequency is located on the lower side or the back side of a cargo including a product having a low replenishment frequency or order frequency. In the loading, the loading order information indicates the order of arranging the cargo including the product with a low replenishment frequency or order frequency on the upper side or the front side of the cargo including the product with a high replenishment frequency or order frequency after arranging the cargo including the product with a high replenishment frequency or order frequency on the lower side or the back side of the loading platform.

information processing device 10. The information processing device 10 includes an acquisition unit 201, a loading information generation model 203, and output units 204 and 35. The acquisition unit 201 acquires cargo information regarding a cargo including a product to be loaded, frequency information indicating a replenishment frequency or an order frequency at a delivery destination of the products, and transport order information indicating a transport order of the cargo including the product to the delivery destination. In a case where the cargo information, the frequency information, and the transport order information are input, the loading information generation model 203 generates the loading information including at least one of the loading position information indicating the position in the loading of the cargo on the loading platform of the vehicle that transports the cargo and the loading order information indicating the order of the cargo in the loading. The output units 204 and 35 output the loading information generated by the loading information generation model.

The worker who performs the loading performs the loading based on the loading position information and the loading order information, so that the cargo including the product with a high replenishment frequency or order frequency is arranged below the cargo including the product with a low replenishment frequency or order frequency or on the back side of the loading platform. Therefore, the worker carrying in the delivery destination at the time of carrying in the cargo can first acquire the cargo including the product with a low replenishment frequency or order frequency and arrange the cargo on the lower side or on the back side of the arrangement position, and arrange the cargo including the product with a high replenishment frequency or order frequency on the upper side or the front side of the product with a low replenishment frequency or order frequency. As a result, in a case where a worker such as a clerk of a delivery destination replenishes a product, it is easy to find and acquire a cargo including a product with a high replenishment frequency or order frequency, and thus, it is possible to improve efficiency of replenishment work of the product.

In the above-described example embodiment, the loading position information indicates an arrangement position where, in the loading, a cargo including a product of the later transport order is on the back side of the loading platform, and a cargo including a product of the earlier transport order is on the front side of the product of the later transport order. The loading order information indicates, in the loading, the order in which the cargo including the product of the earlier transport order is arranged on the front side of the cargo including the product of the later transport order after the cargo including the product of the later transport order is arranged on the back side of the loading platform.

The worker who performs the loading performs the loading based on the loading position information and the loading order information, so that the cargo including the product of the earlier transport order is arranged on the front side of the cargo including the product of the later transport order. As a result, at the delivery destination of the product of which the transport order is earlier, the worker can easily carry out the cargo including the product of the earlier transport order arranged on the front side from the loading platform, so that the loading and unloading work of the cargo can be made efficient.

### Other Example Embodiments

In another example embodiment, the acquisition unit 201 acquires the stock-out tendency information indicating the tendency or frequency of the stock-out for each product at the delivery destination. In the present example embodiment, text information indicating the tendency or frequency of product stock-out at the delivery destination can be adopted as the stock-out tendency information.

A captured image of a display shelf on which products are displayed can be adopted as the stock-out tendency information. In this case, the captured image of the display shelf in a state where products are missing and the captured image in a state where products are not missing can be used as the input information of the loading information generation model 203. An image obtained by photographing identification information of a product such as a product name can be used as the captured image in a state where the product is not missing. In a case where these captured images are input, the loading information generation model 203 can be optimized to output a result indicating which product is missing.

In a case where the cargo information and the stock-out tendency information are input, the loading information generation model 203 outputs, in the loading, the loading position information indicating the arrangement position where the cargo including the product having a high stock-out tendency is on the lower side or the back side of the cargo including the product having a low stock-out tendency. Alternatively, in a case where the stock-out tendency information is input, the loading information generation model 203 may output, in the loading, the loading order information indicating the order of arranging the cargo including the product having a low stock-out tendency on the upper side of the cargo including the product having a high stock-out tendency or on the front side of the loading platform after arranging the cargo including the product having a high stock-out tendency on the lower side or on the back side of the loading platform.

In a case where the worker who performs the loading performs the loading based on the loading position information and the loading order information, the cargo including the product having a high stock-out tendency is loaded under the cargo including the product having a low stock-out tendency or on the back side of the loading platform. Therefore, the worker who carries in a cargo at a delivery destination at the time of carrying in the cargo can first acquire a cargo including a product having a low stock-out tendency and arrange the cargo on the

lower side or the back side of the arrangement position, and arrange a cargo including a product having a high stock-out tendency on the upper side or the front side of the product having a low stock-out tendency. As a result, in a case where a worker such as a clerk at a delivery destination replenishes a product, it is easy to find and acquire a cargo including a product having a high shortage tendency, and thus, it is possible to improve efficiency of replenishment work of the product.

In another example embodiment, the acquisition unit 201 can acquire arrangeable position information indicating a position where the cargo can be arranged at the delivery destination. In the present example embodiment, text information indicating the arrangement position of the cargo including the delivery target product at the delivery destination is adopted as the arrangeable position information. A captured image of a place where the cargo can be placed can be adopted as the arrangeable position information.

In a case where the cargo information and the arrangeable position information are input, the loading information generation model 203 generates arrangement target position information indicating a target position of arrangement of the cargo at the delivery destination. In the present example embodiment, the loading information generation model 203 is optimized by machine learning so as to output the arrangement target position information in a case where the arrangeable position information is input. The loading information generation model 203 can be optimized to output an image including the arrangement target position information.

FIG. 11 is a diagram illustrating an example of an image output by the loading information generation model 203. The image of FIG. 11 illustrates a delivery destination backyard. In the example of FIG. 11, the “arrangeable space” is equivalent to the arrangeable position information. The product A is relevant to a product having a high replenishment frequency or order frequency, and the product B is relevant to a product having a low replenishment frequency or order frequency. The arrangement positions of the product A and the product B illustrated in FIG. 11 are equivalent to the target positions of the cargo including the product A and the cargo including the product B. The example of FIG. 11 illustrates a state in which the product A having a high replenishment frequency or order frequency is arranged in an arrangeable space near the store-side doorway.

The output units 204 and 35 output the arrangement target position information output by the loading information generation model 203. By adopting this configuration, the worker carrying in the cargo at the delivery destination can easily grasp the target position where the cargo to be carried in should be arranged, and thus the efficiency of the cargo carrying work can be improved.

In the example described above, the program includes commands (or software codes) for causing a computer to execute one or more functions described in the example embodiments in a case where the program is read by the computer. The program may be stored in a non-transitory computer readable medium or a tangible storage medium. As an example and not by way of limitation, a computer readable medium or tangible storage medium includes a random-access memory (RAM), a read-only memory (ROM), a flash memory, a solid-state drive (SSD) or other memory technology, a CD-ROM, a digital versatile disk (DVD), a Blu-ray (registered trademark) disk, or other optical disk storages, a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium includes an electric signal, an optical signal, an acoustic signal, or any other form of propagation signal.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely an example to illustrate one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment not explicitly illustrated or described. All of the features or steps illustrated in any one of the drawings for explaining illustrative example embodiments are not necessarily mandatory, and some features or steps may be omitted. The order of the steps illustrated in any of the drawings may be changed as appropriate.

Some or all of the above-described example embodiments may also be described as the following Supplementary Notes, but are not limited to the following Supplementary Notes.

### Supplementary Note 1

A computer implemented method for providing loading information, the method including:

acquiring cargo information regarding a cargo including a product to be loaded and frequency information indicating a replenishment frequency or an order frequency at a delivery destination of the product; and

outputting the loading information by using a loading information generation model that generates, in a case where the cargo information and the frequency information are input, loading information including at least one of loading position information indicating a position of the cargo to be loaded on a loading platform of a vehicle that transports the cargo and loading order information indicating a loading order of the cargo, in which

the loading position information indicates an arrangement position where, in the loading of the cargo, a cargo including a product having a high replenishment frequency or order frequency is on a lower side or a back side of a cargo including a product having a low replenishment frequency or order frequency, and

the loading order information indicates an order in which, in the loading, a cargo including a product having a high replenishment frequency or order frequency is arranged on a lower side or a back side of the loading platform, and then a cargo including a product having a low replenishment frequency or order frequency is arranged on an upper side or a front side of a cargo including a product having a high replenishment frequency or order frequency.

### Supplementary Note 2

A computer implemented method for providing loading information, the method including:

acquiring cargo information regarding a cargo including a product to be loaded and stock-out tendency information indicating a stock-out tendency at a delivery destination of the product; and

outputting the loading information by using a loading information generation model that generates, in a case where the cargo information and the stock-out tendency information are input, loading information including at least one of loading position information indicating a position of the cargo to be loaded on a loading platform of a vehicle that transports the cargo and loading order information indicating a loading order of the cargo, in which

the loading position information indicates an arrangement position where, in the loading of the cargo, a cargo including a product having a high stock-out tendency is on a lower side or a back side of a cargo including a product having a low stock-out tendency, and

the loading order information indicates an order in which, in the loading, a cargo including a product having a high stock-out tendency is arranged on a lower side or a back side of the loading platform, and then a cargo including a product having a low stock-out tendency is arranged on an upper side or a front side of the loading platform of a cargo including a product having a high stock-out tendency.

### Supplementary Note 3

The method according to Supplementary Note 2, in which the loading information generation model uses a captured image of a shelf on which the product is displayed at the delivery destination as the stock-out tendency information.

### Supplementary Note 4

The method according to any one of Supplementary Notes 1 to 3, in which

the acquiring includes acquiring transport order information indicating a transport order of the cargo to the delivery destination,

the loading information generation model generates the loading information in a case where the transport order information is input, and

the loading position information indicates an arrangement position at which, in the loading, a cargo including a product of a later transport order is on a back side of the loading platform, and a cargo including a product of an earlier transport order is on a front side of the product of the later transport order.

### (Supplementary Note 5

The method according to any one of Supplementary Notes 1 to 4, in which

the acquiring includes acquiring transport order information indicating a transport order of the cargo to the delivery destination,

the loading information generation model generates the loading information in a case where the transport order information is input, and

the loading order information indicates an order in which, in the loading, a cargo including a product of a later transport order is arranged on a back side of the loading platform, and then a cargo including a product of an earlier transport order is arranged on a front side of the cargo including the product of the later transport order.

### Supplementary Note 6

The method according to any one of Supplementary Notes 1 to 5, in which

the acquiring includes acquiring arrangeable position information indicating a position where the cargo can be arranged at the delivery destination,

the loading information generation model generates arrangement target position information indicating an arrangement position of the cargo at the delivery destination in a case where the arrangeable position information is input, and

the outputting includes outputting arrangement target position information indicating an arrangement position of the cargo at the delivery destination.

### Supplementary Note 7

The method according to Supplementary Note 6, in which the loading information generation model uses a captured image of a place where the cargo can be placed as the arrangeable position information.

### Supplementary Note 8

A system for providing loading information, the system including:

at least one memory configured to store instructions; and

at least one processor configured to execute the instructions to:

acquire cargo information regarding a cargo including a product to be loaded and frequency information indicating a replenishment frequency or an order frequency at a delivery destination of the product; and

output the loading information by using a loading information generation model that generates, in a case where the cargo information and the frequency information are input, loading information including at least one of loading position information indicating a position of the cargo to be loaded on a loading platform of a vehicle that transports the cargo and loading order information indicating a loading order of the cargo, in which

the loading position information indicates an arrangement position where, in the loading of the cargo, a cargo including a product having a high replenishment frequency or order frequency is on a lower side or a back side of a cargo including a product having a low replenishment frequency or order frequency, and

the loading order information indicates an order in which, in the loading, a cargo including a product having a high replenishment frequency or order frequency is arranged on a lower side or a back side of the loading platform, and then a cargo including a product having a low replenishment frequency or order frequency is arranged on an upper side or a front side of a cargo including a product having a high replenishment frequency or order frequency.

### Supplementary Note 9

A system for providing loading information, the system including:

at least one memory configured to store instructions; and

at least one processor configured to execute the instructions to

acquire cargo information regarding a cargo including a product to be loaded and stock-out tendency information indicating a stock-out tendency at a delivery destination of the product; and

output the loading information by using a loading information generation model that generates, in a case where the cargo information and the stock-out tendency information are input, loading information including at least one of loading position information indicating a position of the cargo to be loaded on a

loading platform of a vehicle that transports the cargo and loading order information indicating a loading order of the cargo, in which

the loading position information indicates an arrangement position where, in the loading of the cargo, a cargo including a product having a high stock-out tendency is on a lower side or a back side of a cargo including a product having a low stock-out tendency, and

the loading order information indicates an order in which, in the loading, a cargo including a product having a high stock-out tendency is arranged on a lower side or a back side of the loading platform, and then a cargo including a product having a low stock-out tendency is arranged on an upper side or a front side of the loading platform of a cargo including a product having a high stock-out tendency.

### Supplementary Note 10

An information processing device for providing loading information, the information processing device including:

at least one memory configured to store instructions; and

at least one processor configured to execute the instructions to:

acquire cargo information regarding a cargo including a product to be loaded and frequency information indicating a replenishment frequency or an order frequency at a delivery destination of the product; and

output the loading information by using a loading information generation model that generates, in a case where the cargo information and the frequency information are input, loading information including at least one of loading position information indicating a position of the cargo to be loaded on a loading platform of a vehicle that transports the cargo and loading order information indicating a loading order of the cargo, in which

the loading position information indicates an arrangement position where, in the loading of the cargo, a cargo including a product having a high replenishment frequency or order frequency is on a lower side or a back side of a cargo including a product having a low replenishment frequency or order frequency, and

the loading order information indicates an order in which, in the loading, a cargo including a product having a high replenishment frequency or order frequency is arranged on a lower side or a back side of the loading platform, and then a cargo including a product having a low replenishment frequency or order

frequency is arranged on an upper side or a front side of a cargo including a product having a high replenishment frequency or order frequency.

### Supplementary Note 11

An information processing device for providing loading information, the information processing device including:

at least one memory configured to store instructions; and

at least one processor configured to execute the instructions to:

acquire cargo information regarding a cargo including a product to be loaded and stock-out tendency information indicating a stock-out tendency at a delivery destination of the product; and

output the loading information by using a loading information generation model that generates, in a case where the cargo information and the stock-out tendency information are input, loading information including at least one of loading position information indicating a position of the cargo to be loaded on a loading platform of a vehicle that transports the cargo and loading order information indicating a loading order of the cargo, in which

the loading position information indicates an arrangement position where, in the loading of the cargo, a cargo including a product having a high stock-out tendency is on a lower side or a back side of a cargo including a product having a low stock-out tendency, and

the loading order information indicates an order in which, in the loading, a cargo including a product having a high stock-out tendency is arranged on a lower side or a back side of the loading platform, and then a cargo including a product having a low stock-out tendency is arranged on an upper side or a front side of the loading platform of a cargo including a product having a high stock-out tendency.

### Supplementary Note 12

A non-transitory recording medium having stored therein a program for providing loading information, the program causing a computer, when the program is executed, to execute:

acquiring cargo information regarding a cargo including a product to be loaded and frequency information indicating a replenishment frequency or an order frequency at a delivery destination of the product; and

outputting the loading information by using a loading information generation model that generates, in a case where the cargo information and the

frequency information are input, loading information including at least one of loading position information indicating a position of the cargo to be loaded on a loading platform of a vehicle that transports the cargo and loading order information indicating a loading order of the cargo, in which

the loading position information indicates an arrangement position where, in the loading of the cargo, a cargo including a product having a high replenishment frequency or order frequency is on a lower side or a back side of a cargo including a product having a low replenishment frequency or order frequency, and

the loading order information indicates an order in which, in the loading, a cargo including a product having a high replenishment frequency or order frequency is arranged on a lower side or a back side of the loading platform, and then a cargo including a product having a low replenishment frequency or order frequency is arranged on an upper side or a front side of a cargo including a product having a high replenishment frequency or order frequency.

### Supplementary Note 13

A non-transitory recording medium having stored therein a program for providing loading information, the program causing a computer, when the program is executed, to execute:

acquiring cargo information regarding a cargo including a product to be loaded and stock-out tendency information indicating a stock-out tendency at a delivery destination of the product; and

outputting the loading information by using a loading information generation model that generates, in a case where the cargo information and the stock-out tendency information are input, loading information including at least one of loading position information indicating a position of the cargo to be loaded on a loading platform of a vehicle that transports the cargo and loading order information indicating a loading order of the cargo, in which

the loading position information indicates an arrangement position where, in the loading of the cargo, a cargo including a product having a high stock-out tendency is on a lower side or a back side of a cargo including a product having a low stock-out tendency, and

the loading order information indicates an order in which, in the loading, a cargo including a product having a high stock-out tendency is arranged on a lower side or a back side of the loading platform, and then a cargo including a product having a low stock-out tendency is arranged on an upper side or a front side of the loading platform of a cargo including a product having a high stock-out tendency.

Some or all of the elements described in Supplementary Notes 4 to 7 depending from Supplementary Notes 1 and 2 may depend from Supplementary Notes 8 to 13 as well with depending relationships similar to those of Supplementary Notes 4 to 7. Some or all of the elements described in Supplementary Note 3 subordinate to Supplementary Note 2 can also be subordinate to Supplementary Notes 9, 11, and 13 by the subordinate relationship similar to that with Supplementary Note 3. Some or all of the elements described in an optional Supplementary Note may be applied to various types of hardware, software, recording means for recording software, systems, and methods.

What is claimed is:

1. A computer implemented method for providing loading information, the method comprising:
acquiring cargo information regarding a cargo including a product to be loaded and frequency information indicating a replenishment frequency or an order frequency at a delivery destination of the product; and
outputting the loading information by using a loading information generation model that generates, in a case where the cargo information and the frequency information are input, loading information including at least one of loading position information indicating a position of the cargo to be loaded on a loading platform of a vehicle that transports the cargo and loading order information indicating a loading order of the cargo, wherein
the loading position information indicates an arrangement position where, in the loading of the cargo, a cargo including a product having a high replenishment frequency or order frequency is on a lower side or a back side of a cargo including a product having a low replenishment frequency or order frequency, and
the loading order information indicates an order in which, in the loading, a cargo including a product having a high replenishment frequency or order frequency is arranged on a lower side or a back side of the loading platform, and then a cargo including a product having a low replenishment frequency or order frequency is arranged on an upper side or a front side of a cargo including a product having a high replenishment frequency or order frequency.

2. The method according to claim 1, wherein
the acquiring includes acquiring transport order information indicating a transport order of the cargo to the delivery destination,
the loading information generation model generates the loading information in a case where the transport order information is input, and
the loading position information indicates an arrangement position at which, in the loading, a cargo including a product of a later transport order is on a back side of the loading platform, and a cargo including a product of an earlier transport order is on a front side of the product of the later transport order.

3. The method according to claim 1, wherein
the acquiring includes acquiring transport order information indicating a transport order of the cargo to the delivery destination,
the loading information generation model generates the loading information in a case where the transport order information is input, and
the loading order information indicates an order in which, in the loading, a cargo including a product of a later transport order is arranged on a back side of the loading platform, and then a cargo including a product of an earlier transport order is arranged on a front side of the cargo including the product of the later transport order.

4. The method according to claim 1, wherein
the acquiring includes acquiring arrangeable position information indicating a position where the cargo can be arranged at the delivery destination,
the loading information generation model generates arrangement target position information indicating an arrangement position of the cargo at the delivery destination in a case where the arrangeable position information is input, and
the outputting includes outputting arrangement target position information indicating an arrangement position of the cargo at the delivery destination.

5. The method according to claim 4, wherein the loading information generation model uses a captured image of a place where the cargo can be placed as the arrangeable position information.

6. A computer implemented method for providing loading information, the method comprising:
acquiring cargo information regarding a cargo including a product to be loaded and stock-out tendency information indicating a stock-out tendency at a delivery destination of the product; and
outputting the loading information by using a loading information generation model that generates, in a case where the cargo information and the stock-out tendency information are input, loading information including at least one of loading position information indicating a position of the cargo to be loaded on a loading platform of a vehicle that transports the cargo and loading order information indicating a loading order of the cargo, wherein
the loading position information indicates an arrangement position where, in the loading of the cargo, a cargo including a product having a high stock-out tendency is on a lower side or a back side of a cargo including a product having a low stock-out tendency, and
the loading order information indicates an order in which, in the loading, a cargo including a product having a high stock-out tendency is arranged on a lower side or a back side of the loading platform, and then a cargo including a product having a low stock-out tendency is arranged on an upper side or a front side of the loading platform of a cargo including a product having a high stock-out tendency.

7. The method according to claim 6, wherein the loading information generation model uses a captured image of a shelf on which the product is displayed at the delivery destination as the stock-out tendency information.

8. The method according to claim 6, wherein
the acquiring includes acquiring transport order information indicating a transport order of the cargo to the delivery destination,
the loading information generation model generates the loading information in a case where the transport order information is input, and
the loading position information indicates an arrangement position at which, in the loading, a cargo including a product of a later transport order is on a back side of the loading platform, and a cargo including a product of an earlier transport order is on a front side of the product of the later transport order.

9. The method according to claim 6, wherein
the acquiring includes acquiring transport order information indicating a transport order of the cargo to the delivery destination,
the loading information generation model generates the loading information in a case where the transport order information is input, and
the loading order information indicates an order in which, in the loading, a cargo including a product of a later transport order is arranged on a back side of the loading platform, and then a cargo including a product of an earlier transport order is arranged on a front side of the cargo including the product of the later transport order.

10. The method according to claim 6, wherein
the acquiring includes acquiring arrangeable position information indicating a position where the cargo can be arranged at the delivery destination,
the loading information generation model generates arrangement target position information indicating an arrangement position of the cargo at the delivery destination in a case where the arrangeable position information is input, and
the outputting includes outputting arrangement target position information indicating an arrangement position of the cargo at the delivery destination.

11. The method according to claim 10, wherein the loading information generation model uses a captured image of a place where the cargo can be placed as the arrangeable position information.

12. A system for providing loading information comprising:
at least one memory configured to store instructions; and
at least one processor configured to execute the instructions to:
acquire cargo information regarding a cargo including a product to be loaded and frequency information indicating a replenishment frequency or an order frequency at a delivery destination of the product; and
output the loading information by using a loading information generation model that generates, in a case where the cargo information and the frequency information are input, loading information including at least one of loading position information indicating a position of the cargo to be loaded on a loading platform of a vehicle that transports the cargo and loading order information indicating a loading order of the cargo, wherein
the loading position information indicates an arrangement position where, in the loading of the cargo, a cargo including a product having a high replenishment frequency or order frequency is on a lower side or a back side of a cargo including a product having a low replenishment frequency or order frequency, and
the loading order information indicates an order in which, in the loading, a cargo including a product having a high replenishment frequency or order frequency is arranged on a lower side or a back side of the loading platform, and then a cargo including a product having a low replenishment frequency or order frequency is arranged on an upper side or a front side of a cargo including a product having a high replenishment frequency or order frequency.

13. The system according to claim 12, wherein
the acquiring includes acquiring transport order information indicating a transport order of the cargo to the delivery destination,
the loading information generation model generates the loading information in a case where the transport order information is input, and
the loading position information indicates an arrangement position at which, in the loading, a cargo including a product of a later transport order is on a back side of the loading platform, and a cargo including a product of an earlier transport order is on a front side of the product of the later transport order.

14. The system according to claim 12, wherein
the acquiring includes acquiring transport order information indicating a transport order of the cargo to the delivery destination,
the loading information generation model generates the loading information in a case where the transport order information is input, and
the loading order information indicates an order in which, in the loading, a cargo including a product of a later transport order is arranged on a back side of the loading platform, and then a cargo including a product of an earlier transport order is arranged on a front side of the cargo including the product of the later transport order.

15. The system according to claim 12, wherein
the acquiring includes acquiring arrangeable position information indicating a position where the cargo can be arranged at the delivery destination,
the loading information generation model generates arrangement target position information indicating an arrangement position of the cargo at the delivery destination in a case where the arrangeable position information is input, and
the outputting includes outputting arrangement target position information indicating an arrangement position of the cargo at the delivery destination.

16. The system according to claim 15, wherein the loading information generation model uses a captured image of a place where the cargo can be placed as the arrangeable position information.
